(19) United States
(12) Patent Application Publication
(10) Pub. No.: US 2015/0363473 A1
(43) Pub. Date: Dec. 17, 2015

(54) DIRECT ANSWER TRIGGERING IN SEARCH

(71) Applicant: MICROSOFT CORPORATION, Redmond, WA (US)

(72) Inventors: Ciya Liao, Fremont, CA (US); Jie Cai, Sunnyvale, CA (US); Zhen Liao, Sunnyvale, CA (US); Ki Yeun Kim, San Jose, CA (US); Saeed Hassanpour, San Fancisco, CA (US)

(73) Assignee: MICROSOFT CORPORATION, Redmond, WA (US)

(21) Appl. No.: 14/306,318

(22) Filed: Jun. 17, 2014

(51) Int. Cl. G06F 17/30

(52) U.S. Cl. CPC G06F 17/30554; G06F 17/30312; G06F 17/30477; G06F 17/3051

(57) ABSTRACT

Architecture comprising a framework for direct answer triggering, a step-by-step answer, and the user interface that facilitates the architecture. Generally, the architecture can comprise an answer datastore that stores an answer index of answer data, and a triggering component configured to invoke answer data in response to processing of a query that triggers a direct answer in a search results page. The triggering component can be configured to send an answer triggering message to the answer datastore and receive the answer data based on the answer triggering message.

### BACKGROUND

The traditional search engine fulfills user intent by providing a combination of search results and some index-based answers. Along with the intense competition in the search engine industry, users clearly prefer the engine that can reach the final results faster. However, the traditional approach requires significant efforts from the user side to filter the irrelevant information and find the desired results.

### SUMMARY

The following presents a simplified summary in order to provide a basic understanding of some novel implementations described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture comprises a framework for direct answer triggering, a step-by-step answer, and the user interface that facilitates the architecture. Generally, the architecture can comprise an answer datastore that stores an answer index of answer data, and a triggering component configured to invoke answer data in response to processing of a query that triggers a direct answer in a search results page. The triggering component can be configured to send an answer triggering message to the answer datastore and receive the answer data based on the answer triggering message.

The architecture can comprise a method, having acts of processing a query to identify a trigger for an answer; generating a triggering message based on the trigger, the triggering message configured to define an answer name and answer constraints, and be applied to an online answer constraints index; and receiving the answer from an answer datastore based on the triggering message, the answer returned as a definitive answer derived via the online answer constraints index and presented in a results page.

The architecture can comprise an alternative method, having acts of processing a query to identify a trigger for an answer; generating a triggering message based on the trigger, the triggering message configured to define an answer name and answer constraints, and be applied to an online answer key-attribute index; applying the triggering message and one or more grammar rules to the answer key-attribute index; receiving the answer from an online answer datastore, the answer is a direct answer based on the triggering message and one or more grammar rules; and presenting the direct answer in a search results page.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates an answer triggering and deployment framework in accordance with the disclosed architecture.

FIG. 3 illustrates the deployment workflow of the triggering management and deployment tool of FIG. 2.

FIG. 4 illustrates a system of workflow, dataflow, and data structure of the answer triggering online model.

FIG. 5 illustrates an example answer data triggering data flow.

FIG. 6 illustrates an example initial view of a step-by-step answer in an exemplary user interface framework.

FIG. 7 illustrates an example interim view of the step-by-step answer in the exemplary user interface framework.

FIG. 8 illustrates an example final view of the step-by-step answer in the exemplary user interface framework.

FIG. 9 illustrates a method in accordance with the disclosed architecture.

FIG. 10 illustrates an alternative method in accordance with the disclosed architecture.

FIG. 11 illustrates a block diagram of a computing system that executes direct answer triggering in search in accordance with the disclosed architecture

### DETAILED DESCRIPTION

Along with the intense competition in the search engine industry, users clearly prefer the engine that can provide the final results faster. In a response by the industry, there is a drive to provide direct answers (e.g., step-by-step) to users based on accurate query intent understanding.

The disclosed architecture provides a generic framework and mechanism for direct answer triggering with highly accurate query and user intent understanding. In addition, the architecture proposes an answer idea that fulfills considerable user intent while the user is looking for step-by-step instructions (e.g., a step-by-step listing to perform a yoga pose, step-by-step instructions for a recipe, step-by-step instructions for computer hardware/software troubleshooting, etc.).

As used herein, an answer is an approach utilized in the search engine to directly fulfill a user's query intent. The answer is represented directly on the SERP (search engine results page) without requiring user to click on a link (e g , uniform resource locator (URL)) of the web document. For example, for query {<actor name>height}, the answer, 5′7″, is shown as text on the SERP rather than requiring the user to navigate away from the SERP to a source of the height information for the <actor name>.

Answer triggering refers to the technique that triggers an answer on the search result page given a user query. Answer data refers to supporting data for answers, which can comprise fact data, realtime stock data, weather data, map and geo-location data, application checklist, how-to answers, etc.

A step-by-step answer is a type of answer which can utilize step-by-step instructions or information to guide user on the completion a task. For example, a query {how to bake a carrot cake} can be input to search for ingredients and recipes for carrot cake. The recipes can then be an answer in the form by step-by-step instructions.

The architecture for the answer triggering and deployment framework can employ online workflow, offline workflow, and a fast deployment and management tool for answer triggering. The online workflow starts from the user query. The query is then processed through an online triggering component that comprises online triggering logic, which at least invokes online answer data to determine whether the query will trigger any answers. If an answer will be triggered, the triggering component generates a triggering message, which specifies information such as the triggering answer name, triggering constraints, which attributes to retrieve from an answer constraint index, and so on. The answer is then retrieved from an answer data online storage based on the specific answer triggering message.

In the offline workflow, one or more models are developed for the online triggering component. Offline answer data is utilized to be formatted as constraint indexed offline triggering attributes, and used subsequently to develop machine learning model(s) and/or rule based model(s) for triggering the specific answer. A whitelist can be generated by both the machine learning models and rule based models. The models can be deployed to the online triggering component in the online workflow, and the constraint index of offline attributes and the whitelist can be deployed to an online direct access store for online triggering logic of the triggering component. Offline answer data can be used to deploy the online constraint index answer data store.

The triggering management and deployment tool can be implemented to comprise three components: a triggering management component for the management of trigger logic and trigger data; a publisher component for publishing and refreshing data via a scheduler, online answer data publisher, and online triggering model publisher; and, an analysis component for automatic defect detection, offline measurement management, and an online/offline metrics monitoring dashboard.

In one implementation a scalable cross-index can be employed to use any attribute to retrieve any other attribute. Searching can be performed by key and/or attribute. The index is then in key-value data store for lookup.

Reference is now made to the drawings, wherein like reference numerals are used to refer to like elements throughout. In the following description, for purposes of explanation, numerous specific details are set forth in order to provide a thorough understanding thereof. It may be evident, however, that the novel implementations can be practiced without these specific details. In other instances, well known structures and devices are shown in block diagram form in order to facilitate a description thereof. The intention is to cover all modifications, equivalents, and alternatives falling within the spirit and scope of the claimed subject matter.

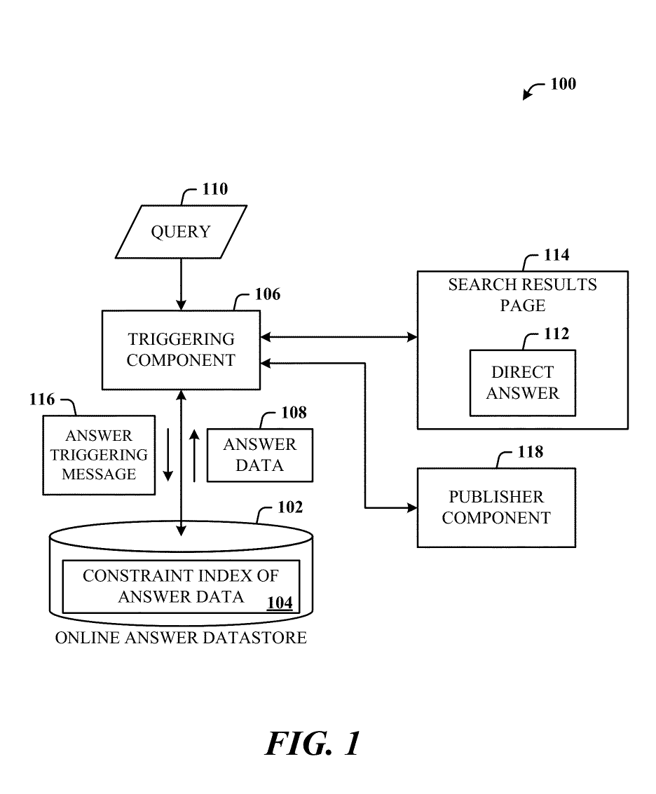

FIG. 1 illustrates a system 100 in accordance with the disclosed architecture. The system 100 can include an answer datastore 102 that stores an answer index of answer data 104, and a triggering component 106 configured to invoke answer data 108 from the answer datastore 102 in response to processing of a query 110. The query processing triggers a direct answer 112 in a search results page 114. The triggering component 106 is configured to send an answer triggering message 116 to the answer datastore 102 and receive the answer data 108 based on the answer triggering message 116. The direct answer 112 can be a step-by-step answer presented in the search results page 114.

The triggering component 106 comprises triggering logic configured to perform whitelist query matching, phrase matching, and synonym substitution. The triggering component 106 comprises triggering logic configured to perform rule matching to explain the entire query based on a set of rules and classification to predict a desired answer.

The answer index of answer data is a key-attribute index of answer data. The answer triggering message 116 specifies a triggering answer name, triggering constraints, and attributes to be retrieved from the key-attribute index. The answer data 108 is directly generated for the query 110 based on rules matching and classification.

The triggering component 106 further comprises an aggregator configured to aggregate information related to at least one of an attribute dictionary, synonyms, auto-generated and human-written rules, query whitelists, or a query classifier. The system 100 can further comprise a publisher component 118 configured to schedule refresh of a direct access store and triggering logic of the triggering component 106.

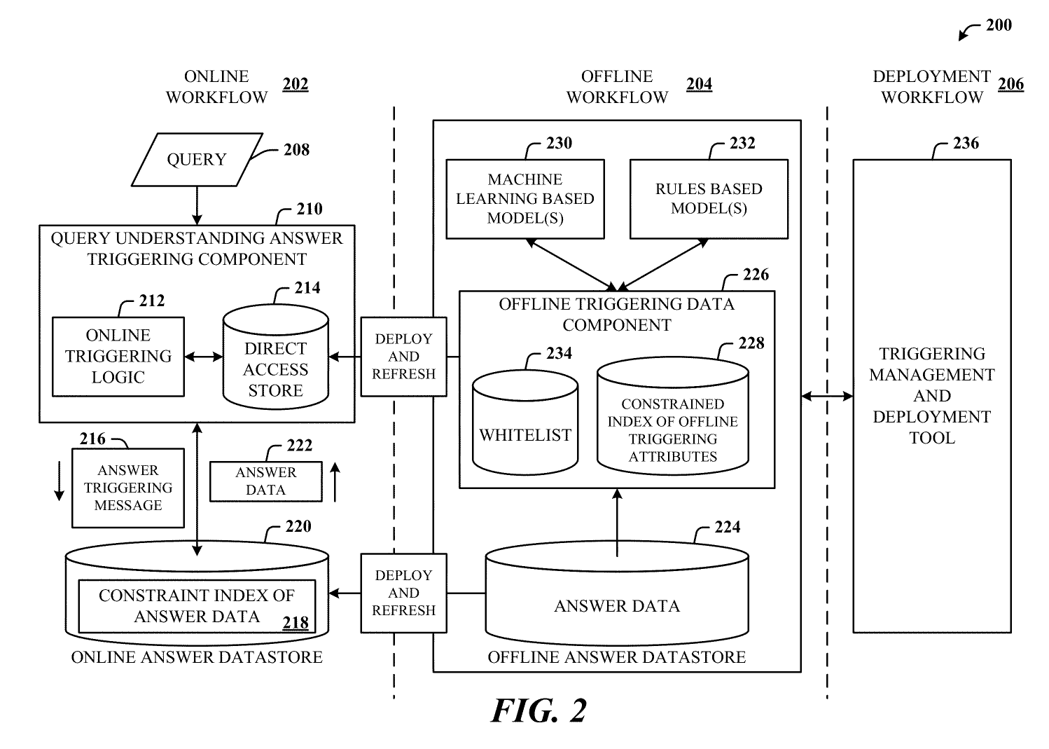

FIG. 2 illustrates an answer triggering and deployment framework 200 in accordance with the disclosed architecture. The framework 200 can include three components: an online workflow 202, offline workflow 204, and a deployment workflow 206.

The online workflow 202 begins with receipt of the user query 208 into a query understanding answer triggering component 210 (similar to the triggering component 106 of FIG. 1). Once received into the triggering component 210, the query 208 is processed through online triggering logic 212 (of the triggering component 210) and invokes online data in a direct access store 214 to determine if the query 208 will trigger any answers. If an answer will be triggered, the triggering component 210 generates a triggering message 216 (similar to answer triggering message 116 of FIG. 1), which can comprise a triggering answer name, one or more triggering constraints, which attributes to retrieve from a constraint (key-attribute) index 218, etc. Answer data 222 (similar to answer data 108 of FIG. 1) is then retrieved from the index 218 (stored in an online answer datastore 220 and similar to the answer datastore 102 of FIG. 1) based on the specific answer triggering message 216.

The offline workflow 204 details how to produce models for online triggering component 210. Offline answer data of an offline answer datastore 224 can be sent to an offline triggering data component 226 and, utilized and formatted as a constraint index of offline triggering attributes 228 and also used to develop machine learning model(s) 230 and/or rule based model(s) 232, which enable triggering of the specific answer (answer data 222). A whitelist 234 can be generated using both the machine learning model(s) 230 and rule based model(s) 232.

Both models (230 and 232) can be deployed to the online triggering logic 212 in the online workflow 202, and the constraint index of offline triggering attributes 228 and the whitelist 234 can be deployed and refreshed to the online direct access store 214 for access by the online triggering logic 212. The offline answer data can be used to deploy and refresh the online constraint index of answer data in the online datastore 220.

The online workflow 202 and offline workflow 204 are both enabled by the deployment workflow 206 via a triggering management and deployment tool 236, which is described in greater detail hereinbelow.

As an example, the input data to the online answer triggering component 210 is the query 208, while the defined output format of the triggering component 210 can be an SQL (structured query language)-statement such as a unified API (application program interface) similar to APIs used by existing systems and/or infrastructures. For example, the triggering answer format of the query 208, “what is most famous action movies by jet li”, can be the following:

SELECT Movie_Name
FROM Movie_Answer_Database
WHERE

(

Genre = “action”
Actor = “jet li”

)

ORDER BY popularity DESC;

It can be known that the user actually wants to get the movie name of actor “jet li” with the genre “action”. For the answer database 220, the answer data 222 can be obtained based on the SQL-statement like “query”.

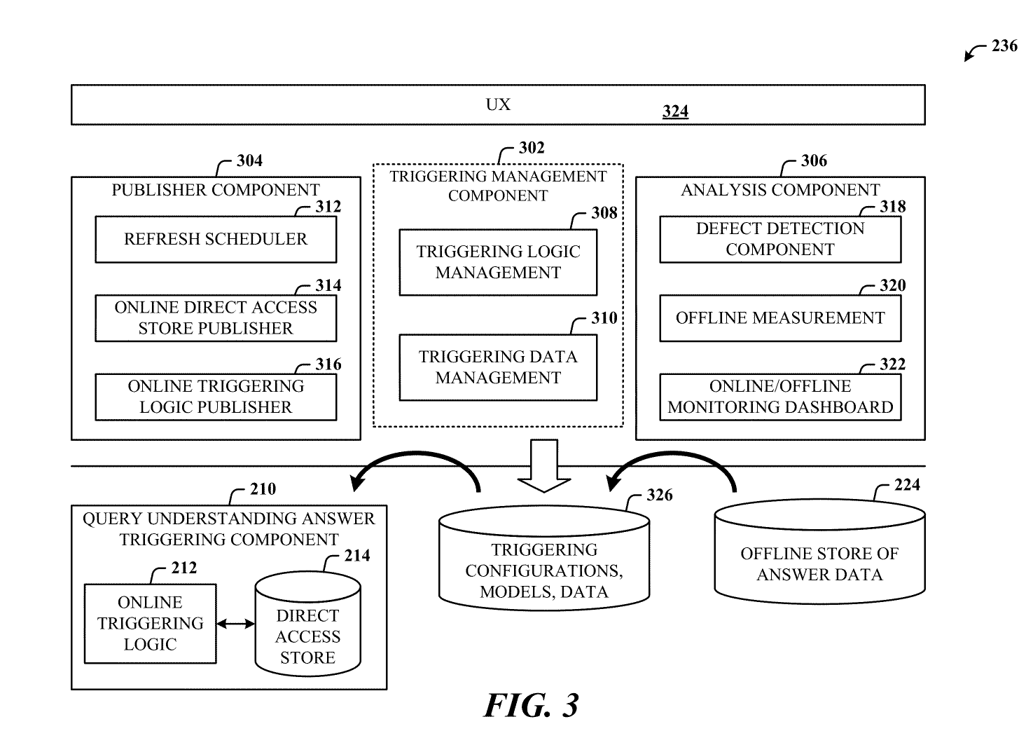

FIG. 3 illustrates the deployment workflow of the triggering management and deployment tool 236 of FIG. 2. The tool 236 comprises at least three components: a triggering management component 302, a publisher component 304, and an analysis component 306.

The triggering management component 302 further includes triggering logic management 308 configured to manage the online triggering logic 212, and triggering data management 310 configured to manage the offline triggering data component 226.

The publisher component 304 performs publishing of data and signals, and refresh scheduling thereof. More specifically, the publisher component 304 comprises a refresh scheduler 312 configured to schedule data refreshing to the online direct access store 214 and the online triggering logic 212; an online direct answer access publisher 314 configured to publish data to the online direct access store 214; and, an online triggering logic publisher 316 configured to publish data to the online triggering logic 312.

The analysis component 306 comprises functions/operations for automatic defect detection via a defect detection component 318, offline measurement management via an offline measure component 320, and online/offline metrics monitoring via an online/offline metrics monitoring dashboard 322.

The management tool 236 can further comprise an interface with the user experience (UX) 324 and interface with online and offline triggering data 326.

This framework enables fast answer onboarding by providing a scalable answer triggering mechanism, automatic answer monitoring, and third-party contributions to the answer data.

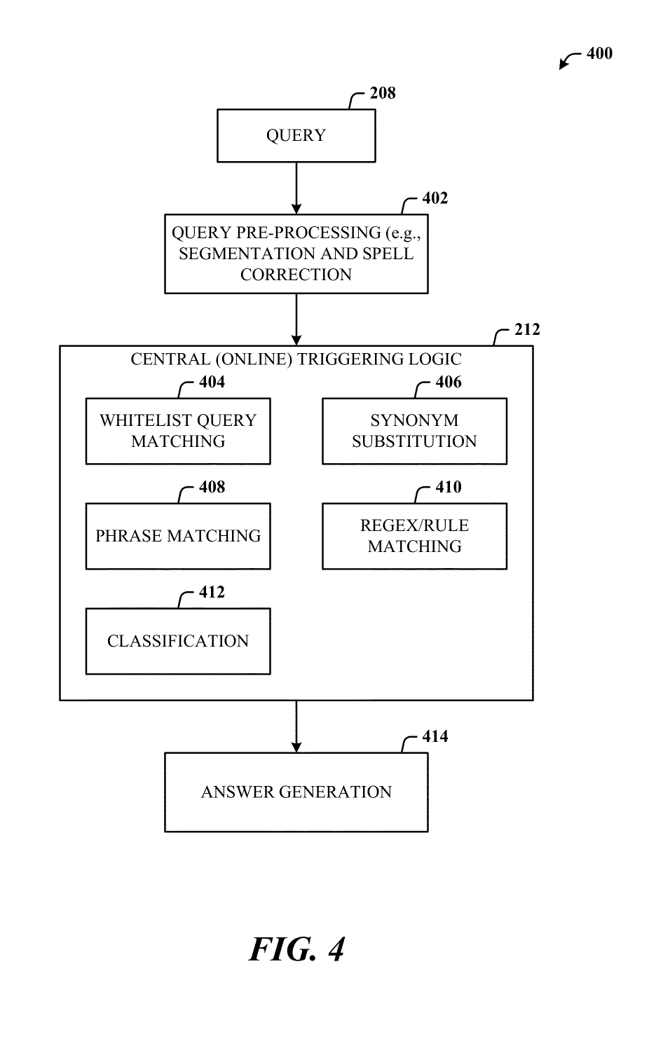

FIG. 4 illustrates a system 400 of workflow, dataflow, and data structure of the answer triggering online model. The online triggering logic workflow 202 comprises several parts: query pre-processing, central triggering logic, and the result generation.

Flow begins by receiving the query 208. At 402, the query 208 is then pre-processed. Pre-processing can include, but is not limited to, segmentation and spell correction, for example. The query 208 is first pre-processed mainly by segmenting the query into phrases. For some queries, which include typographical errors and have previously been in the query logs, these queries are replaced with the correct form. The query segmentation techniques can vary; the query logs and web documents are utilized to build a good segmentation algorithm (or method). The segmentation is basically n-gram based; while for English, a unigram-based method can be employed to segment the queries. For an English query containing n words, the query is segmented as n phrases.

With respect to the central triggering logic (the online triggering logic 212), operations can be performed related to whitelist query matching 404, synonym substitution 406, phrase matching 408, regex/rule matching 410, and classification 412.

Whitelist query matching 404 relates to those queries which already have the answers (e.g., Beijing weather query triggers the weather answer) and are specified as vetted as to reliability, etc. These answers are passed directly to the step of result generation.

For phrases which can be synonyms of existing popular forms (e.g., “SFO”→“San Francisco airport”), the phrases are substituted as popular forms, as relates to synonym substitution 406. The synonym dataset can be built from the query logs where queries sharing a threshold number of clicked web documents are good candidates for synonym substitution 406.

With respect to phrase matching 408, for each substring of a phrase, the substring is matched with the pre-built dictionary, and which can then be mapped to the predefined attributes (facts) of the given dataset. For example, “Beijing” can be matched as the “city” in the location database.

With respect to regex (regular expression)/rule matching 410, after performing phrase matching 408, each phrase can be tagged with an “attribute”, and where the phrase cannot be found in a dictionary, the phrase can be tagged as “none”. This matching operation then begins to search and find the most likely tags that can be used to explain the whole query based on the predefined rules, on top of the dictionary. For example, a query “San Francisco airport map” can be mapped as “<location>map” but not “<city>airport map”. The rules can be defined as regular expression form, text form, and/or context-free grammar based form.

With respect to classification 412, machine learning approaches are adopted into the process of target answer classification. This means the prediction of the kind of answer the user most wants. The classification model is complementary to the rule-based matching, where the cases are not easily be matched by rules. For example, “san francisco airport map”→“<map>” can be one rule, while the classification method can be used to classify a query such as “sfo airport map”, or even “san francisco airport maps view”.

Flow is then from the central triggering logic 212 to answer generation 414. Based on the output of central triggering logic 212, it is known if the given query 208 matched the predefined rules or classifier, and the kind of answer the user wants. The answer can then be directly generated. It may also be possible to further customize the answer based on the dataset and the need of the application.

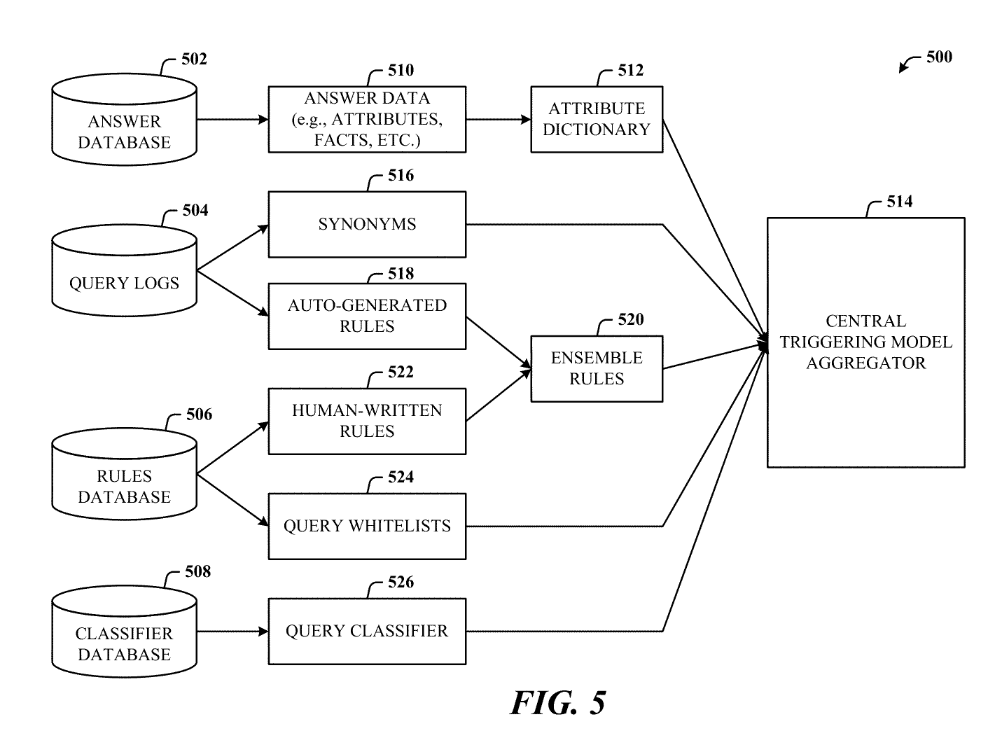

FIG. 5 illustrates answer data triggering data flow 500. The data inside the answer triggering system is derived primarily from following sources: an answer database 502 (similar to answer datastores 102 and 220), query logs 504, a rules database 506, and a classifier database 508. Following is a description of the dataflow.

The answer database 502 stores the final useful answer data 510. The answer data 510 is pre-processed to associate the answer data 510 with a unique identifier (ID), which can be a globally unique identifier (GUID) (e.g., containing multi-bit information such as 128 bits, 256 bits, etc.). Each data item can include several attributes (or facts), which can be used as the answer to satisfy the user query. For example, a country data item can comprise several attributes such as “capital”, “population”, etc. The attributes can support a query such as “where is the capital of <country>?”, “how about the population of <country>?”, and so on. The answer data 510 is used to generate an attribute dictionary 512, which dictionary 512 can be used in a central triggering model aggregator 514.

The query logs 504 are employed for at least two scenarios: generating synonyms 516 and for enabling automatically generated (auto-generated) rules 518. The synonyms 516 can be in phrase mode and the phrases can be substituted by each other. For example, a phrase “canon camera” can be a good form of its synonym “cameras canon”. The synonyms 516 can be passed directly into the aggregator 514. The auto-generated rules 518 are input to an ensemble rules block 520 that assembles the auto-generated rules 518 with human-written rules 522, which ensemble rules 520 are then passed into the aggregator 514.

The rules database 506 is employed to store the query whitelists 524 and human-written rules 522. The human-written rules 522 can be in the form of regular expressions, strings, and/or context-free grammar. The query whitelists 524 are input directly into the aggregator 514.

The classifier database 508 stores the machine learning based classifier (used for generating the machine learning based model(s) 230), which is different from the rule-based classifier (used for generating the rules-based model(s) 232). The detailed information in the classifier can be the model file with parameters, the name of the used model, the testing results of precision/recall/coverage, the offline dataset used to train the model, and so on.

Following is an example direct step-by-step answer derived in accordance with the disclosed architecture. The following Table 1 is short answer data for “Garlic Chicken”. The Field Name can be an attribute, and the Recipe-Name, can be a key.

TABLE 1
Answer Data for “Garlic Chicken”

| Field Name | Value |
|---|---|
| Recipe-Name | Garlic Chicken |
| Cooking-Directions | 1. Preheat oven to 425 degrees F. (220 |
| | degrees C.). |
| | 2. Warm the garlic and olive oil to |
| | blend the flavors. In a separate dish, |
| | combine the bread crumbs and |
| | Parmesan cheese. Dip the chicken |
| | breasts in the olive oil and garlic |
| | mixture, then into the bread crumb |
| | mixture. Place in a shallow baking |
| | dish. |
| | 3. Bake in the preheated oven for 30 to |
| | 35 minutes, until no longer pink and |
| | juices run clear. |
| All-Ingredients | 2 teaspoons crushed garlic |
| | ¼ cup grated parmesan cheese |
| | ¼ cup olive oil |
| | ¼ cup dry bread crumbs |
| | 4 skinless, boneless chicken breast halves |
| Prepare-Time | 20 minutes |
| Cook-Time | 30 minutes |
| Total-Time | 50 minutes |

Table 2 shows some grammar rules that can be applied to the online constraints index. The dollar symbol ($) can be used as the prefix for the item attributes in the dataset, and the question mark (?) can be used for the prefix of target answer attribute.

TABLE 2
Constraint Index Grammar Rules

| Rule | Specification of Rule |
|---|---|
| What is the cooking time of $Recipe- | This rule returns the cooking |
| Name ?Cook-Time | time for the recipe. |
| What is the cooking steps of $Recipe- | This rule returns the cooking |
| Name ?Cooking-Directions | directions for the recipe. |
| How to cook $Recipe-Name | This rule returns the cooking |
| ?Cooking-Directions | directions for the recipe. |

The steps can decomposed within the cooking directions into a more detailed representation. For example, the dataset can be extended, as shown in Table 3.

TABLE 3
Answer Data Field for “Garlic Chicken” With Detailed Steps

| Field Name | Value |
|---|---|
| Recipe-Name | Garlic Chicken |
| Cooking-Directions | 1. Preheat oven to 425 degrees F. |
| | (220 degrees C.). |
| | 2. Warm the garlic and olive oil to |
| | blend the flavors. In a separate |
| | dish, combine the bread crumbs |
| | and Parmesan cheese. Dip the |
| | chicken breasts in the olive oil |
| | and garlic mixture, then into the |
| | bread crumb mixture. Place in a |
| | shallow baking dish. |
| | 3. Bake in the preheated oven for |
| | 30 to 35 minutes, until no |
| | longer pink and juices run |
| | clear. |
| All-Ingredients | 2 teaspoons crushed garlic |
| | ¼ cup grated parmesan cheese |
| | ¼ cup olive oil |
| | ¼ cup dry bread crumbs |
| | 4 skinless, boneless chicken breast |
| | halves |
| Prepare-Time | 20 minutes |
| Cook-Time | 30 minutes |
| Total-Time | 50 minutes |
| Cooking-Step1 | Preheat oven to 425 degrees F. (220 |
| | degrees C.). |
| Cooking-Step2 | Warm the garlic and olive oil to blend |
| | the flavors. In a separate dish, combine |
| | the bread crumbs and Parmesan |
| | cheese. Dip the chicken breasts in the |
| | olive oil and garlic mixture, then into |
| | the bread crumb mixture. Place in a |
| | shallow baking dish. |
| Cooking-Step3 | Bake in the preheated oven for 30 to 35 |
| | minutes, until no longer pink and juices |
| | run clear. |
| Preheat-Oven-Degree-Setting | 435 degrees F. (220 degrees C.) |
| Bake-Time | 30 to 35 minutes |

Here, Cooking-Stepl to Cooking-Step3 are customized in this specific recipe of “Garlic Chicken”. More broadly, Cooking-Step1 can be expanded to show other similar recipe steps for that given step, for example, to N steps (Cooking-StepN), where N is the step number in other recipes. Additionally, the rules can be continuously improved/expanded/added-to as shown in Table 4.

TABLE 4
Additional Constraint Index Grammar Rules

| Rule | Specification of Rule |
|---|---|
| What is the first cooking step of $Recipe- | This rule returns the first |
| Name ?Cooking-Step1 | cooking step for the |
| | recipe. |
| How to set the oven degree in $Recipe- | This rule returns the oven |
| Name ?Preheat-Oven-Degree-Setting | degree setting for the |
| | $Recipe-Name. |

Using the method illustrated in the above example, these kinds of step-by-step answer approached can be generalized to yoga gestures, firewall settings, email application configurations, hardware assembly/disassembly, personal care, and so on.

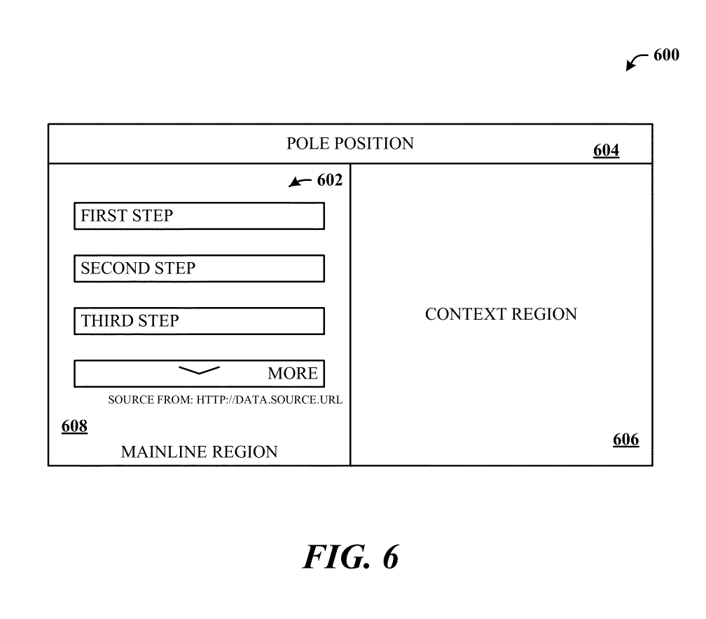

FIG. 6 illustrates an example initial view 600 of a step-by-step answer 602 in an exemplary user interface framework. The framework comprises a pole position 604, a context region 606, and a mainline region 608. In this example implementation, the answer 602 is partially presented in the mainline region 608 showing three steps: a first step, a second step, and a third step. A “More” object is presented that enables the user expansion of the additional steps. The sources of the answer data can also be presented (e.g., “Source From: HTTP://data.source.url”).

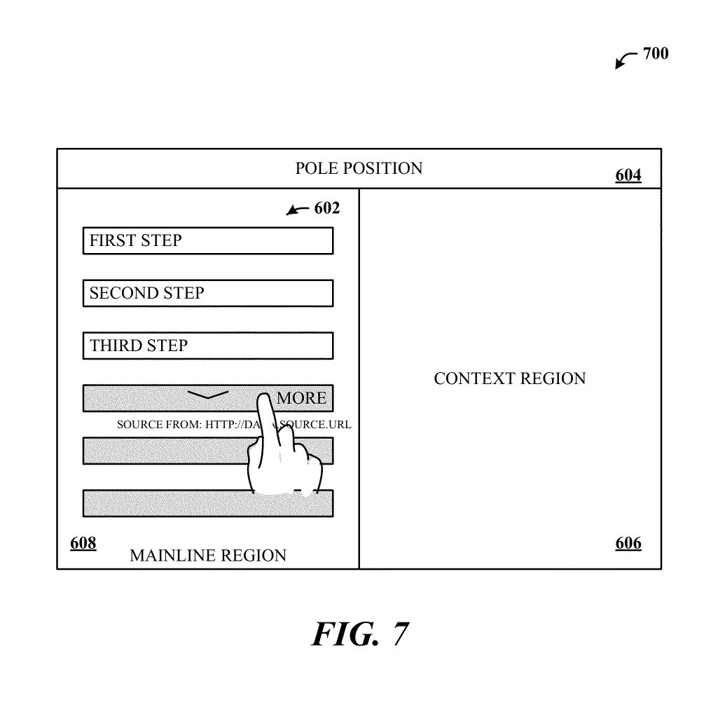

FIG. 7 illustrates an example interim view 700 of the step-by-step answer 602 in the exemplary user interface framework. Here, the user interacts with the More object to access and present additional steps of the step-by-step answer 602.

The user interaction capability can be tactile enabled and/or gesture-enabled, whereby the user employs one or more gestures for interaction. For example, the gestures can be natural user interface (NUI) gestures. NUI may be defined as any interface technology that enables a user to interact with a device in a “natural” manner, free from artificial constraints imposed by input devices such as mice, keyboards, remote controls, and the like. Examples of NUI methods include those methods that employ gestures, broadly defined herein to include, but not limited to, tactile and non-tactile interfaces such as speech recognition, touch recognition, facial recognition, stylus recognition, air gestures (e.g., hand poses and movements and other body/appendage motions/poses), head and eye tracking, voice and speech utterances, and machine learning related at least to vision, speech, voice, pose, and touch data, for example.

NUI technologies include, but are not limited to, touch sensitive displays, voice and speech recognition, intention and goal understanding, motion gesture detection using depth cameras (e.g., stereoscopic camera systems, infrared camera systems, color camera systems, and combinations thereof), motion gesture detection using accelerometers/gyroscopes, facial recognition, 3D displays, head, eye, and gaze tracking, immersive augmented reality and virtual reality systems, all of which provide a more natural user interface, as well as technologies for sensing brain activity using electric field sensing electrodes (e.g., electro-encephalograph (EEG)) and other neuro-biofeedback methods.

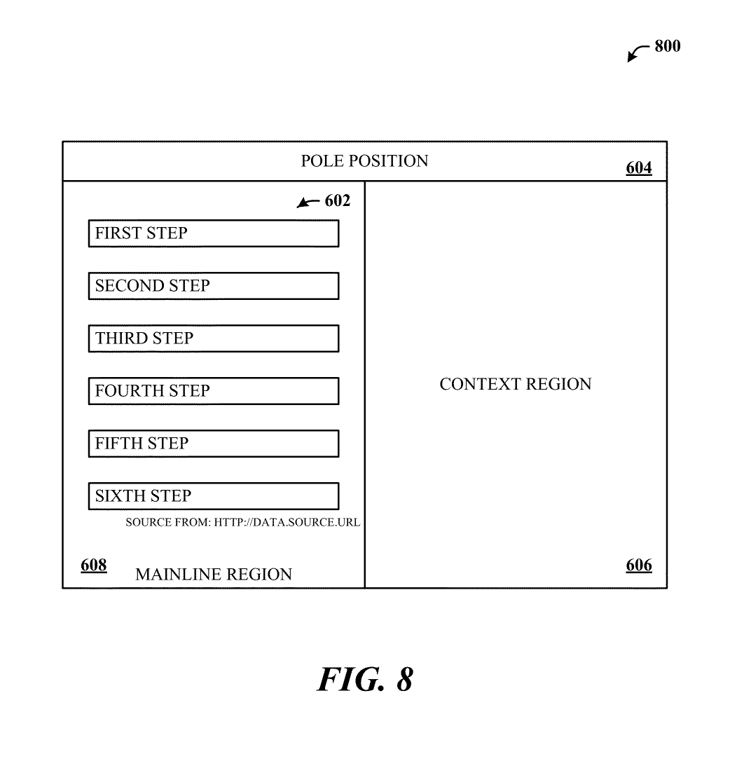

FIG. 8 illustrates an example final view 800 of the step-by-step answer 602 in the exemplary user interface framework. Here, the architecture reacts in response to the user action with the More object to access and present all the steps (three remaining steps) of the step-by-step answer 602.

It is to be understood that in the disclosed architecture certain components can be combined, rearranged, omitted, and additional components may be included. Additionally, in some implementations, all or some of the components are present on the client, while in other implementations some components may reside on a server or are provided by a local or remote service.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

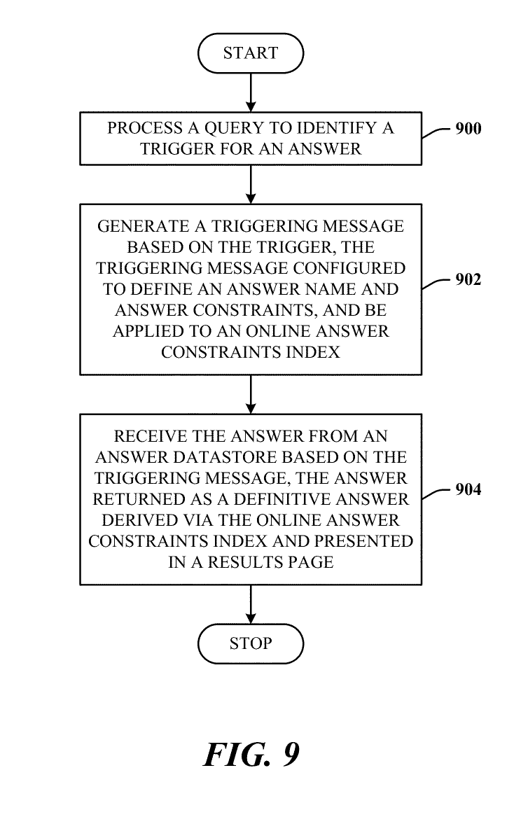

FIG. 9 illustrates a method in accordance with the disclosed architecture. At 900, a query is processed to identify a trigger for an answer. At 902, a triggering message is generated based on the trigger. The triggering message is configured to define an answer name and answer constraints, and be applied to an online answer constraints index. At 904, the answer is received from an answer datastore based on the triggering message. The answer can be returned as a definitive answer derived via the online answer constraints index and presented in a results page.

The method can further comprise outputting the definitive answer as a step-by-step answer in a search results page. The method can further comprise applying one or more grammar rules to the index to enable direct receipt of the definitive answer. The method can further comprise invoking online answer data to determine if the query will trigger any answers.

The method can further comprise employing a whitelist for a direct access store and online triggering logic. The method can further comprise developing a machine-learning based model and a rules-based model for access by answer triggering logic. The method can further comprise scheduling updates to answer triggering logic from a direct access store publisher and an online triggering model publisher.

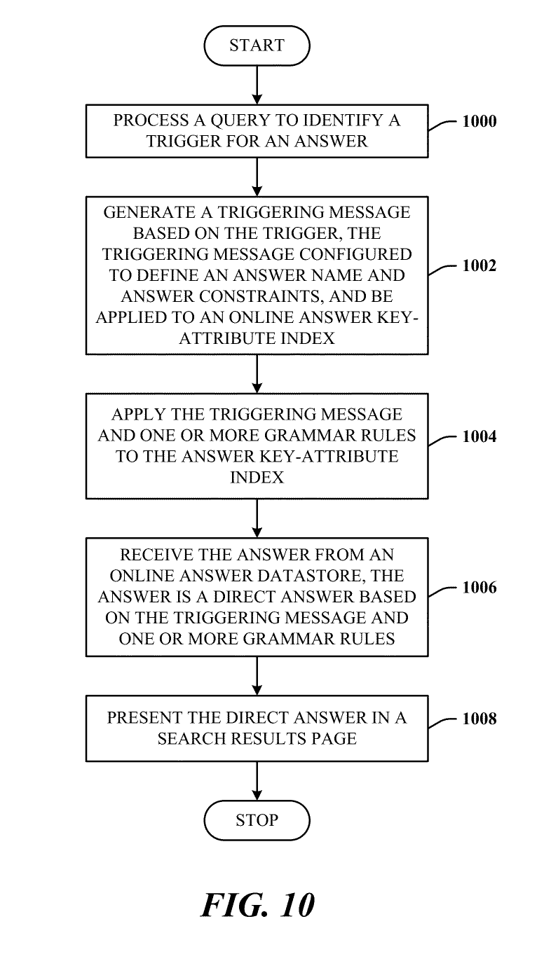

FIG. 10 illustrates an alternative method in accordance with the disclosed architecture. The method can be implemented in a computer-readable storage medium comprising computer-executable instructions that when executed by a microprocessor, cause the microprocessor to perform the following acts.

At 1000, a query is processed to identify a trigger for an answer. At 1002, a triggering message is generated based on the trigger. The triggering message can be configured to define an answer name and answer constraints, and be applied to an online answer key-attribute index. At 1004, the triggering message and one or more grammar rules are applied to the answer key-attribute index. At 1006, the answer is received from an online answer datastore. The answer is a direct answer based on the triggering message and one or more grammar rules. At 1008, the direct answer is presented in a search results page.

The method can further comprise invoking online answer data to determine if the query will trigger any answers. The method can further comprise developing the grammar rules from at least one of a machine-learning based model or a rules-based model. The method can further comprise pre-processing the query for defect detection. The method can further comprise presenting the direct answer as a partial step-by-step answer that is expandable to all answer steps in response to user interaction.

As used in this application, the terms “component” and “system” are intended to refer to a computer-related entity, either hardware, a combination of software and tangible hardware, software, or software in execution. For example, a component can be, but is not limited to, tangible components such as a microprocessor, chip memory, mass storage devices (e.g., optical drives, solid state drives, and/or magnetic storage media drives), and computers, and software components such as a process running on a microprocessor, an object, an executable, a data structure (stored in a volatile or a non-volatile storage medium), a module, a thread of execution, and/or a program.

By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

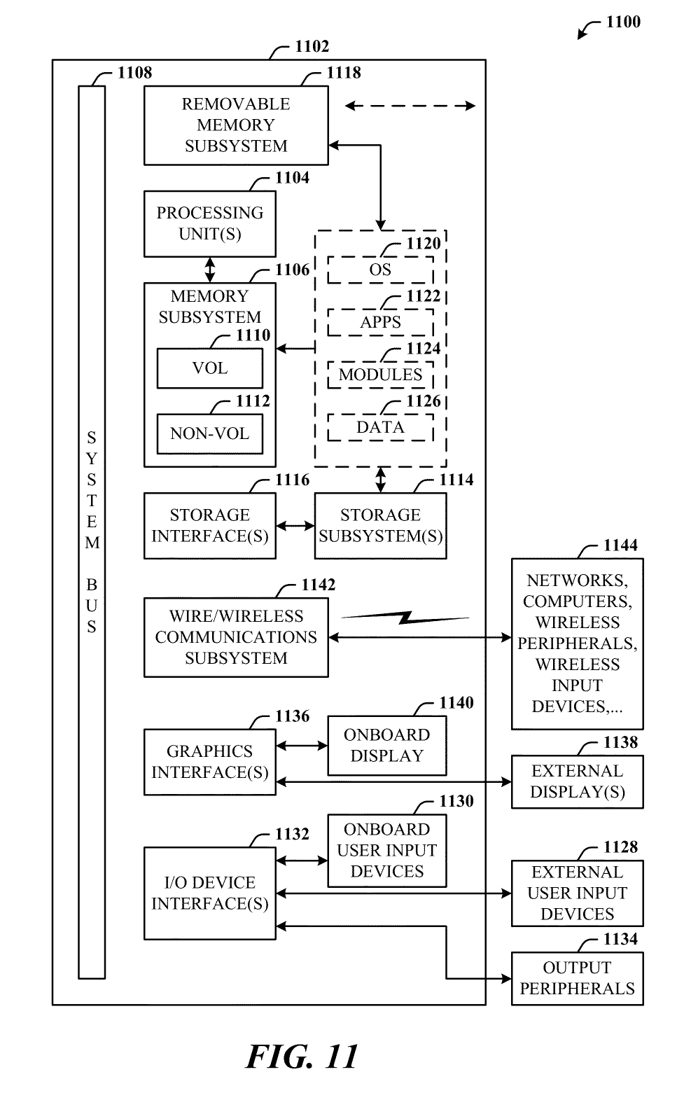

Referring now to FIG. 11, there is illustrated a block diagram of a computing system 1100 that executes direct answer triggering in search in accordance with the disclosed architecture. However, it is appreciated that the some or all aspects of the disclosed methods and/or systems can be implemented as a system-on-a-chip, where analog, digital, mixed signals, and other functions are fabricated on a single chip substrate.

In order to provide additional context for various aspects thereof, FIG. 11 and the following description are intended to provide a brief, general description of the suitable computing system 1100 in which the various aspects can be implemented. While the description above is in the general context of computer-executable instructions that can run on one or more computers, those skilled in the art will recognize that a novel implementation also can be implemented in combination with other program modules and/or as a combination of hardware and software.

The computing system 1100 for implementing various aspects includes the computer 1102 having microprocessing unit(s) 1104 (also referred to as microprocessor(s) and processor(s)), a computer-readable storage medium such as a system memory 1106 (computer readable storage medium/media also include magnetic disks, optical disks, solid state drives, external memory systems, and flash memory drives), and a system bus 1108. The microprocessing unit(s) 1104 can be any of various commercially available microprocessors such as single-processor, multi-processor, single-core units and multi-core units of processing and/or storage circuits. Moreover, those skilled in the art will appreciate that the novel system and methods can be practiced with other computer system configurations, including minicomputers, mainframe computers, as well as personal computers (e.g., desktop, laptop, tablet PC, etc.), hand-held computing devices, microprocessor-based or programmable consumer electronics, and the like, each of which can be operatively coupled to one or more associated devices.

The computer 1102 can be one of several computers employed in a datacenter and/or computing resources (hardware and/or software) in support of cloud computing services for portable and/or mobile computing systems such as wireless communications devices, cellular telephones, and other mobile-capable devices. Cloud computing services, include, but are not limited to, infrastructure as a service, platform as a service, software as a service, storage as a service, desktop as a service, data as a service, security as a service, and APIs (application program interfaces) as a service, for example.

The system memory 1106 can include computer-readable storage (physical storage) medium such as a volatile (VOL) memory 1110 (e.g., random access memory (RAM)) and a non-volatile memory (NON-VOL) 1112 (e.g., ROM, EPROM, EEPROM, etc.). A basic input/output system (BIOS) can be stored in the non-volatile memory 1112, and includes the basic routines that facilitate the communication of data and signals between components within the computer 1102, such as during startup. The volatile memory 1110 can also include a high-speed RAM such as static RAM for caching data.

The system bus 1108 provides an interface for system components including, but not limited to, the system memory 1106 to the microprocessing unit(s) 1104. The system bus 1108 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 1102 further includes machine readable storage subsystem(s) 1114 and storage interface(s) 1116 for interfacing the storage subsystem(s) 1114 to the system bus 1108 and other desired computer components and circuits. The storage subsystem(s) 1114 (physical storage media) can include one or more of a hard disk drive (HDD), a magnetic floppy disk drive (FDD), solid state drive (SSD), flash drives, and/or optical disk storage drive (e.g., a CD-ROM drive DVD drive), for example. The storage interface(s) 1116 can include interface technologies such as EIDE, ATA, SATA, and IEEE 1394, for example.

One or more programs and data can be stored in the memory subsystem 1106, a machine readable and removable memory subsystem 1118 (e.g., flash drive form factor technology), and/or the storage subsystem(s) 1114 (e.g., optical, magnetic, solid state), including an operating system 1120, one or more application programs 1122, other program modules 1124, and program data 1126.

The operating system 1120, one or more application programs 1122, other program modules 1124, and/or program data 1126 can include items and components of the system 100 of FIG. 1, items and components of the framework 200 of FIG. 2, items and workflow of FIG. 3, items and workflow of FIG. 4, items and components of the data flow of FIG. 5, views of FIG. 6-8, and the methods represented by the flowcharts of FIGS. 9 and 10, for example.

Generally, programs include routines, methods, data structures, other software components, etc., that perform particular tasks, functions, or implement particular abstract data types. All or portions of the operating system 1120, applications 1122, modules 1124, and/or data 1126 can also be cached in memory such as the volatile memory 1110 and/or non-volatile memory, for example. It is to be appreciated that the disclosed architecture can be implemented with various commercially available operating systems or combinations of operating systems (e.g., as virtual machines).

The storage subsystem(s) 1114 and memory subsystems (1106 and 1118) serve as computer readable media for volatile and non-volatile storage of data, data structures, computer-executable instructions, and so on. Such instructions, when executed by a computer or other machine, can cause the computer or other machine to perform one or more acts of a method. Computer-executable instructions comprise, for example, instructions and data which cause a general purpose computer, special purpose computer, or special purpose microprocessor device(s) to perform a certain function or group of functions. The computer executable instructions may be, for example, binaries, intermediate format instructions such as assembly language, or even source code. The instructions to perform the acts can be stored on one medium, or could be stored across multiple media, so that the instructions appear collectively on the one or more computer-readable storage medium/media, regardless of whether all of the instructions are on the same media.

Computer readable storage media (medium) exclude (excludes) propagated signals per se, can be accessed by the computer 1102, and include volatile and non-volatile internal and/or external media that is removable and/or non-removable. For the computer 1102, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

A user can interact with the computer 1102, programs, and data using external user input devices 1128 such as a keyboard and a mouse, as well as by voice commands facilitated by speech recognition. Other external user input devices 1128 can include a microphone, an IR (infrared) remote control, a joystick, a game pad, camera recognition systems, a stylus pen, touch screen, gesture systems (e.g., eye movement, body poses such as relate to hand(s), finger(s), arm(s), head, etc.), and the like. The user can interact with the computer 1102, programs, and data using onboard user input devices 1130 such a touchpad, microphone, keyboard, etc., where the computer 1102 is a portable computer, for example.

These and other input devices are connected to the microprocessing unit(s) 1104 through input/output (I/O) device interface(s) 1132 via the system bus 1108, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 1132 also facilitate the use of output peripherals 1134 such as printers, audio devices, camera devices, and so on, such as a sound card and/or onboard audio processing capability.

One or more graphics interface(s) 1136 (also commonly referred to as a graphics processing unit (GPU)) provide graphics and video signals between the computer 1102 and external display(s) 1138 (e.g., LCD, plasma) and/or onboard displays 1140 (e.g., for portable computer). The graphics interface(s) 1136 can also be manufactured as part of the computer system board.

The computer 1102 can operate in a networked environment (e.g., IP-based) using logical connections via a wired/wireless communications subsystem 1142 to one or more networks and/or other computers. The other computers can include workstations, servers, routers, personal computers, microprocessor-based entertainment appliances, peer devices or other common network nodes, and typically include many or all of the elements described relative to the computer 1102. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 1102 connects to the network via a wired/wireless communication subsystem 1142 (e.g., a network interface adapter, onboard transceiver subsystem, etc.) to communicate with wired/wireless networks, wired/wireless printers, wired/wireless input devices 1144, and so on. The computer 1102 can include a modem or other means for establishing communications over the network. In a networked environment, programs and data relative to the computer 1102 can be stored in the remote memory/storage device, as is associated with a distributed system. It will be appreciated that the network connections shown are exemplary and other means of establishing a communications link between the computers can be used.

The computer 1102 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related technology and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
an answer datastore that stores an answer index of answer data;
a triggering component configured to invoke answer data in response to processing of a query that triggers a direct answer in a search results page, the triggering component configured to send an answer triggering message to the answer datastore and receive the answer data based on the answer triggering message; and
at least one microprocessor configured to execute computer-executable instructions in a memory associated with the answer datastore and the triggering component.

2. The system of claim 1, wherein the triggering component comprises triggering logic configured to perform whitelist query matching, phrase matching, and synonym substitution.

3. The system of claim 1, wherein the triggering component comprises triggering logic configured to perform rule matching to explain the entire query based on a set of rules and classification to predict a desired answer.

4. The system of claim 1, wherein the answer index is a key-attribute index of answer data, the answer triggering message specifies a triggering answer name, triggering constraints, and attributes to be retrieved from the key-attribute index.

5. The system of claim 1, wherein the answer data is directly generated for the query based on rules matching and classification.

6. The system of claim 1, wherein the triggering component further comprises an aggregator configured to aggregate information related to at least one of an attribute dictionary, synonyms, auto-generated and human-written rules, query whitelists, or a query classifier.

7. The system of claim 1, wherein the direct answer is a step-by-step answer presented in the search results page.

8. The system of claim 1, further comprising a publisher component configured to schedule refresh of a direct access store and triggering logic of the triggering component.

9. A method, comprising acts of:
processing a query to identify a trigger for an answer;
generating a triggering message based on the trigger, the triggering message configured to define an answer name and answer constraints, and be applied to an online answer constraints index; and
receiving the answer from an answer datastore based on the triggering message, the answer returned as a definitive answer derived via the online answer constraints index and presented in a results page.

10. The method of claim 9, further comprising outputting the definitive answer as a step-by-step answer in a search results page.

11. The method of claim 9, further comprising applying one or more grammar rules to the index to enable direct receipt of the definitive answer.

12. The method of claim 9, further comprising invoking online answer data to determine if the query will trigger any answers.

13. The method of claim 9, further comprising employing a whitelist for a direct access store and online triggering logic.

14. The method of claim 9, further comprising developing a machine-learning based model and a rules-based model for access by answer triggering logic.

15. The method of claim 9, further comprising scheduling updates to answer triggering logic from a direct access store publisher and an online triggering model publisher.

16. A computer-readable storage medium comprising computer-executable instructions that when executed by a microprocessor, cause the microprocessor to perform acts of:
processing a query to identify a trigger for an answer;
generating a triggering message based on the trigger, the triggering message configured to define an answer name and answer constraints, and be applied to an online answer key-attribute index;
applying the triggering message and one or more grammar rules to the answer key-attribute index;
receiving the answer from an online answer datastore, the answer is a direct answer based on the triggering message and one or more grammar rules; and
presenting the direct answer in a search results page.

17. The computer-readable storage medium of claim 16, further comprising invoking online answer data to determine if the query will trigger any answers.

18. The computer-readable storage medium of claim 16, further comprising developing the grammar rules from at least one of a machine-learning based model or a rules-based model.

19. The computer-readable storage medium of claim 16, further comprising pre-processing the query for defect detection.

20. The computer-readable storage medium of claim 16, further comprising presenting the direct answer as a partial step-by-step answer that is expandable to all answer steps in response to user interaction.
